(19) United States
(12) Patent Application Publication
(10) Pub. No.: US 2013/0231981 A1
(43) Pub. Date: Sep. 5, 2013

(54) CONSTRUCTION TRADE BUILDING INFORMATION MANAGEMENT SYSTEM, SOFTWARE AND METHOD

(71) Applicant: Tiffany Hosey Brown, Oakton, VA (US)

(72) Inventor: Tiffany Hosey Brown, Oakton, VA (US)

(73) Assignee: Tiffany Hosey Brown, Oakton, VA (US)

(21) Appl. No.: 13/988,218

(22) PCT Filed: Jan. 24, 2012
(86) PCT No.: PCT/US12/22421

§ 371 Date: May 17, 2013

Related U.S. Application Data
(60) Provisional application No. 61/461,950, filed on Jan. 25, 2011.

(51) Int. Cl. G06Q 10/06; G06Q 50/08

(52) U.S. Cl. CPC G06Q 10/0639; G06Q 50/08
USPC 705/7.38

(57) ABSTRACT

A construction information system for managing construction projects in real-time, comprising a server, database in communication with a computer or other mobile device and a remote client having a software application enabling communication between the server and client

### FIELD OF THE INVENTION

The present invention relates to a computer-based construction-specific information management system, software and method. More particularly, the present invention relates a construction-specific information management system, software application and method, configured to interface with architecture software, and enable web-based remote access of integrated real-time construction information, thereby enabling a user to track and aggregate comprehensive building information throughout a construction process.

### BACKGROUND

Purpose-built for building information modeling (BIM), Autodesk® Revit® Architecture building design software helps architects and designers capture and analyze early concepts, and maintain designs through documentation and construction. Present inventory tracking applications and systems configured to work in conjunction with the BIM software architecture are deficient in enabling real-time information to be remotely transmitted to and from the construction site. Software applications, such as COBIE, are adequate for their intended purposes, however, construction-specific information that is uploaded through the COBIE software application cannot be remotely accessed and updated in real-time from the construction site by personnel at the site.

### SUMMARY OF THE INVENTION

The ability to track progress, and keep track of inventory in real-time during all phases of construction, can be vital in maintaining project efficiency. The present invention provides a system and software application that enables web-based remote access to pre-loaded construction information in real-time. The present invention enables onsite personnel to access pre-loaded information, such as plans, or drawing specifications, remotely from the field. The present invention not only provides real-time information to on-site personnel, but also enables construction stakeholders (i.e., owners, architects, engineers, project managers, construction trades, construction executives) to manage the project with real-time information about every stage of the construction progress.

Further, the information system in conjunction with the software application, in accordance with the present invention, tracks inventory from the point of delivery at the construction site, and, archives information and data related to materials and equipment, such that if and when changes to architectural drawings occur, unused materials and equipment can be used as replacement inventory in the future. Further, the system collects and archives all information utilized to construct the building for use during construction and post-construction for facilities management and maintenance.

This summary is provided to introduce concepts in a simplified form that are further described in the detailed description of the invention. This summary is not intended to identify key or essential inventive concepts of the claimed subject matter, nor is it intended for determining the scope of the claimed subject matter. The components of the invention are an information system process for managing a specified construction project in real-time, comprising a server, database in communication with a computer and a remote client having a software application enabling communication between the server and the client. The system process comprises preloading architectural drawing data and a first construction information set onto a server and relational database. The next steps comprise remotely inputting a second construction project installation information set from the specified construction project and comparing the second project installation information set to architectural drawing data and the first project installation information set to identify construction information discrepancies and construction progress.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein, in which:

FIGS. 1-12 illustrate the functionality of the software application and information system, in accordance with the present invention such that:

FIG. 1 illustrates a system block diagram showing the functional diagram of the information system and software application, in accordance with the present invention;

FIG. 2 is a flow chart diagram illustrating the process of the information system;

FIG. 3 illustrates an example of a screen shot of the data entry interface of the software application;

FIG. 4 is a diagram illustrating an example of the data set relationships in the system database;

FIG. 5 illustrates an example of a screen shot of the products portal of the software application;

FIG. 6 illustrates a screen display of user data input screen;

FIG. 7 illustrates an example of a screen shot of a reports portal of the software application;

FIG. 8 is an Attribute value screen display;

FIG. 9 is an example of a Bulletin Index or Change Order;

FIG. 10 illustrates a functional overview of the system and software application, in accordance with the present invention;

FIG. 11 illustrates a flow diagram of the management system preconstruction process;

FIG. 12 illustrates a flow diagram of the inventory control standard operating procedure;

FIG. 13 illustrates a flow diagram of the construction by Field Crews Process;

FIG. 14 illustrates a flow diagram of the changes in Architectural Drawings process;

FIG. 15 illustrates a flow diagram of the system reporting process;

FIG. 16 illustrates a flow diagram of the archival inventory tracking process;

FIG. 17 illustrates a flow diagram of the turnover standard operating procedure process; and

FIG. 18 illustrates an example of a products portal screen display.

### DETAILED DESCRIPTION OF THE INVENTION

Particular embodiments of the present invention will now be described in greater detail with reference to the figures.

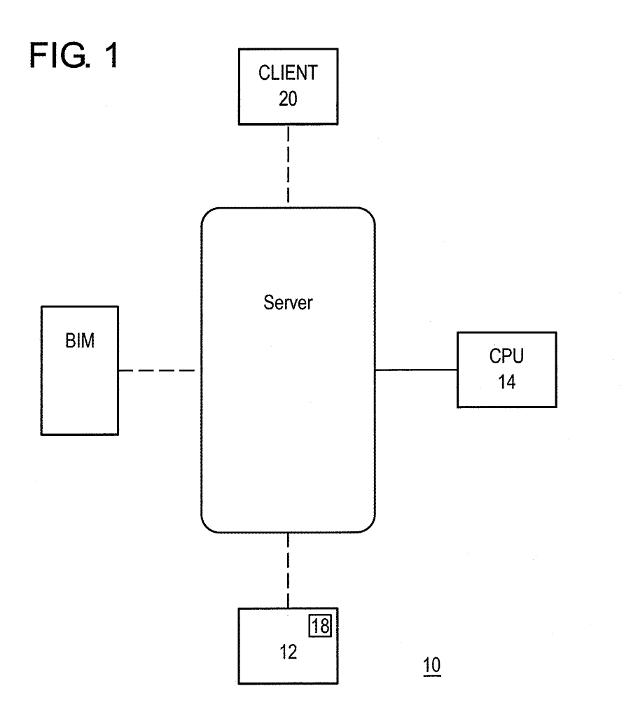

Referring now to FIG. 1, there is shown a functional block diagram of one example of the construction data information system 10, in accordance with the present invention. The system 10 comprises a software application 12, one or more computers 14 comprising a screen display, a server 16, a database 18, and one or more clients 20, in communication with the server 16 and database 18. The database 18 can be any of several products currently available and generally known to those skilled in the art. However, in the preferred embodiment, it is contemplated that the database is a relational database, such as a SQL Database Server or similar type.

In the present invention, the client 20 can be a PDA, computer, IPAD, smart phone, or other wireless, or mobile device, generally known in the art. It is contemplated that the components, CPU 14 and client 20 of the system 10, have a web-based browser application providing a viewable portal cooperatively with the software application 12. Accordingly, the system 10 uses a wireless communication system generally known in the art, to communicate between the client 20 and the server 16.

In the present embodiment the system 10 or software application 12 can individually or jointly comprise a relational database 18 and server 16. The software application 12 is web-based, enabling construction-specific project data and information to be accessed locally by the computer 14, and remotely via the client 20. In the present embodiment, the software application 12 comprises Microsoft.net C+ programming language, which is generally compatible with most common BIM software protocols used by architecture software providers, such as BENTLEY or RIVET. A further description of the Microsoft.net C+ language is provided via reference at www.microsoft.com. Notably, it is contemplated that the software application 12 can comprise other programming languages, such as Hypertext Preprocessor “php,” Java, or Linux, for example, without departing from the scope of the present invention.

As stated, the software application 12 uses computer language compatible with BIM software program architecture, such as RIVET, BENTLEY or other construction software applications, generally known in the art. The software application 12 formats pre-loaded construction data and organizes the data into pre-configured data sets, enabling the information to be displayed and manipulated using a web-based browser application, provided by the computer 14 and/or client 20.

The construction-specific information stored in the database 18 is retrievable via data packets which are wirelessly streamed from the server 16 and accessed remotely by the client 20 via a web-based browser. In another embodiment, the information is stored locally on the client 20 and accessible using the software application 12. As information is input into the software application 12 in real-time at the host computer 14 and remotely from the client 20 the software application 12 compares the input information to the pre-loaded data stored in the database 18 to identify any discrepancies which will be discussed later.

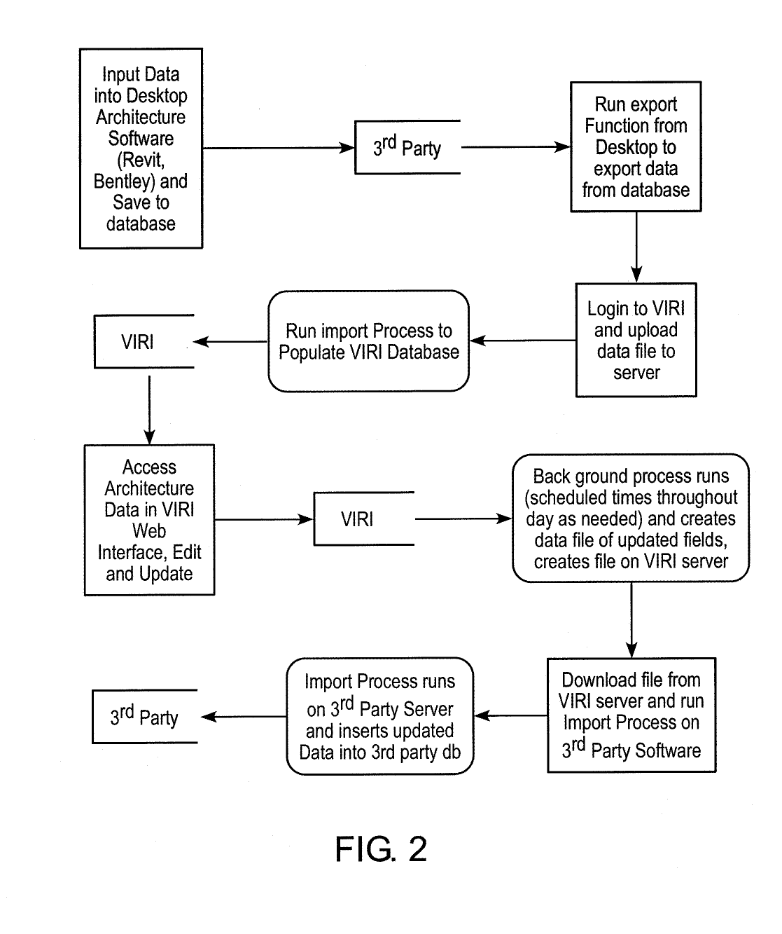

Referring now to FIG. 2, there is shown a flow chart diagram illustrating the process and/or function of the system 10 cooperatively with the software application 12. As shown, data files Step 21 that contain architectural plans, materials, building specifications, etc. are initially stored on third party architecture software application 22, such as Revit or Bentley. Notably, in another embodiment, this data can also be stored locally on a separate database in communication with the architecture software and the system 10. Using the software application 12, building personnel runs the export function of the third party architecture software Step 23, login to the software application 12 and uploads or exports Step 24 the construction-specific information to the server of the system 10, and database 18. This information can be architectural drawings, building specifications, floor plans, materials, and any other sort of information desired. Notably, this information is formatted for compatibility with the third party architecture software protocols.

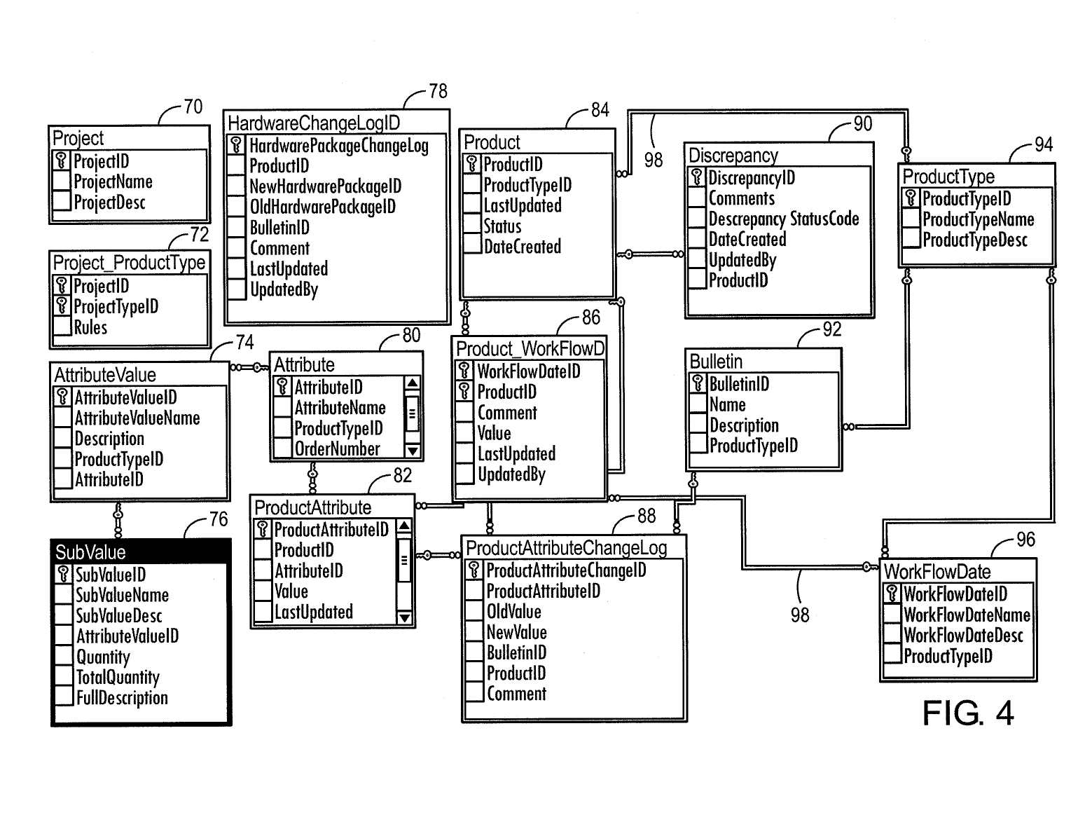

In the present embodiment, construction-specific information and/or data is provided in a generally text format. However, it is contemplated that the construction-specific information can be in other formats, such as XML, without departing from the scope of the present information. Once the construction-specific data file is loaded into the database 18. The software application 12 and database 18 organize the data into data sets in accordance with the data's attributes Step 25. One example of relational database 18, data fields and attributes is illustrated in FIG. 4, and will be discussed later in this application.

Once the data is communicated to the system 10, the software application 12 uses a pre-programmed filter to process the data. In this embodiment, the user pre-selects the type of project / job that the data is being used for and accordingly, the data is arranged in the database 18 according to the selected project data set attributes stored in database 18. The software application 12 processes the data and arranges the data into a series of pre-customized data fields. For example, in the present embodiment, the customized data fields are preconfigured for a door installation project. Accordingly, each data field has attributes relating to the construction-specific data for a door installation project. Notably it is contemplated that other forms of construction-specific data, such as air conditioning system, plumbing, electrical system, phone system, or other templates pertaining to the construction industry are pre-loaded into the software application 12 and database 18, without departing from the scope of the present invention. This data is viewable by the user by a web-based portal Step 26. The software application 12, for example running in the background, automatically compares information pertaining to the data attributes loaded in the database 18 from the third party architecture server, to data uploaded locally via the CPU or remotely via the client 20, and creates data files of updated fields and files in the software application 12 Step 27. In comparing preloaded data to present data, discrepancies in information is detected by the software application 12 and reported in real-time to users remotely and locally connected. The process of Step 27 can be scheduled to run at preset times throughout the day and/or run as needed. Also, at such times the various data files, including those that have been updated, stored in the database 18 of the software application 12 are downloaded so as to be imported in the third party architecture software 22 Step 28. Thereafter, the downloaded files, including those that have been updated, from the database 18 of the software application 12 are imported into the third party architecture software 22 Step 29.

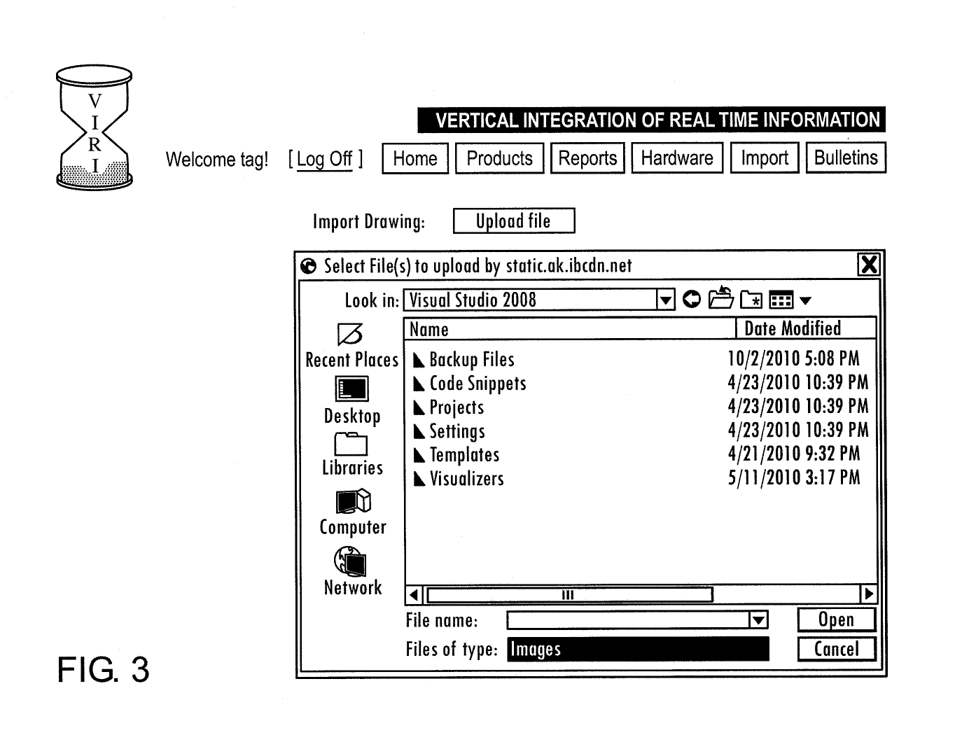

FIG. 3, illustrates a display screen generated by the software application 12. As shown, using the software application 12, the user uploads construction-specific information stored in a designated data file. After the construction-specific information is uploaded into the database 18, the software application 12 arranges and compares the data to the pre-configured software application's data fields and information is sorted according to attributes.

FIG. 4 is a diagram illustrating and example of the relational database 18 organization, in accordance with the present invention. As shown, the database 18 comprises a series of data sets (70-96) to organize construction-specific-information. In this example, the database 18 has data set specific subheadings to organize construction specific data for a Door Installation Project. Notably, as stated, it is contemplated that the database 18 is configurable to provide data sets for numerous different types of construction related projects and construction trades, without departing from the scope of the present invention. It is further contemplated that the software application 12 can detect the number of data fields required by querying the uploaded data, and based on such information generates “n” number of fields to arrange the data, without departing from the scope of the present invention.

As shown in this Door Installation Project example, the data sets provided are labeled Project 70, ProjectProduct Type 72, Attribute Value 74, Subvalue 76, Hardware Change Log 78, Attribute 80, Product Attribute 82, Product 84, Product Work_FlowD 86, ProductAttributeChangeLog 88, Discrepancy 90, Bulletin 92, ProductType 94, and WorkFlowDate 96. Each data set has a series of sub-headings representing data set attributes that are used to categorize the construction-specific data in the database 18. For example, Project Data Set 70 stores information related to Project ID, Project Name, and Project Description. In another example, Bulletin Data Set 92 has a data set containing a Bulletin ID, Name, Description and Product Type ID used to store data related to a specific Bulletin and information related to that Bulletin, including a Description and a Product Type ID. A list of all of the data set attributes in this example is further provided in Appendix A of this application, and incorporated herein by reference.

FIG. 4 also illustrates the shared relationship between data sets with one or more connecting lines 98. For example, data entered by a user regarding a Bulletin is assigned the aforementioned attributes for a Bulletin data set 92 and shared with the Product Type Data Set 94 and the Product Attribute Change Log Data Set 88. Without specifically explaining every connecting line, further examples of shared relationships of the data set is this example are illustrated in FIG. 4. It should be noted that these connecting lines defining various relationships can be set in any number of ways depending on the project and its purpose.

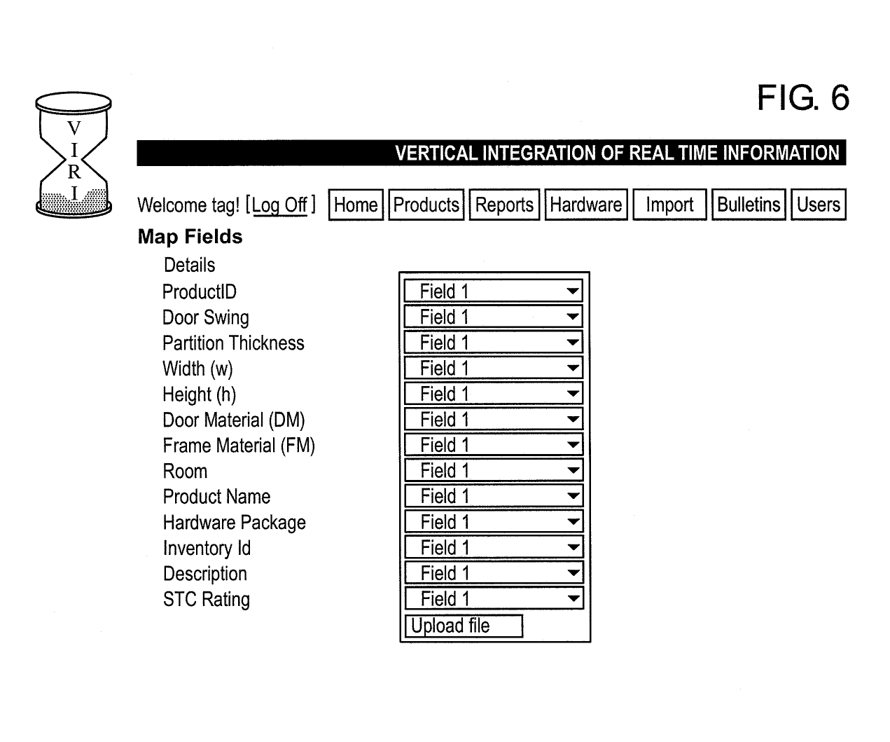

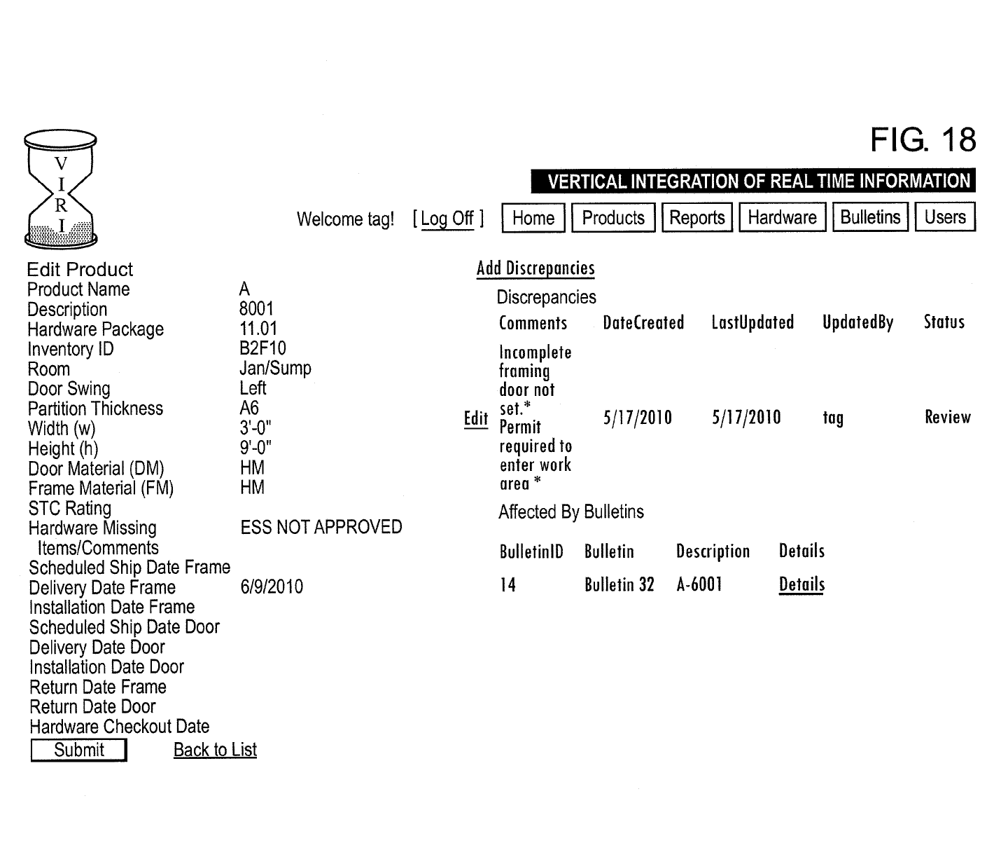

FIG. 6, illustrates an example of the user's screen display input portal of the viewable data fields by the software application 12, for a construction project. As shown, in the present example, viewable data fields are provided for: 1) the location of the door and frame; 2) the kind of material the door and frame is made of; 3) the dimension of the door and frame; 4) the partition size of the walls adjacent to the door and frame; 5) swing of the door and frame; 6) the ship date of the door and frame; 7) delivery date of the door and frame; 8) the installation date of the door and frame; 9) the sound rating, if any, of the door and frame; 10) the hardware package assigned to the door and frame; and, 11) the architectural drawings depicting the door and frame. This portal enables a user to update information. As information is input through this user's portal, it is processed, compared to pre-loaded data and can be modified within the database 18 by a user using this portal. This information is further displayable on a detailed products portal in FIG. 18, which will be discussed further in this application.

Once the data is uploaded, the software application 12 organizes the data in the database 18 in accordance with the pre-configured data sets relative to the selected project. The software application 12 provides a series of user friendly portals enabling a user to view data stored in the database and specifically data sets. The portals are configurable in accordance with the desired construction project. The software application 12 provides cross referencing of information between data sets. The relational database indicated in FIG. 4 illustrates the shared information between the data sets.

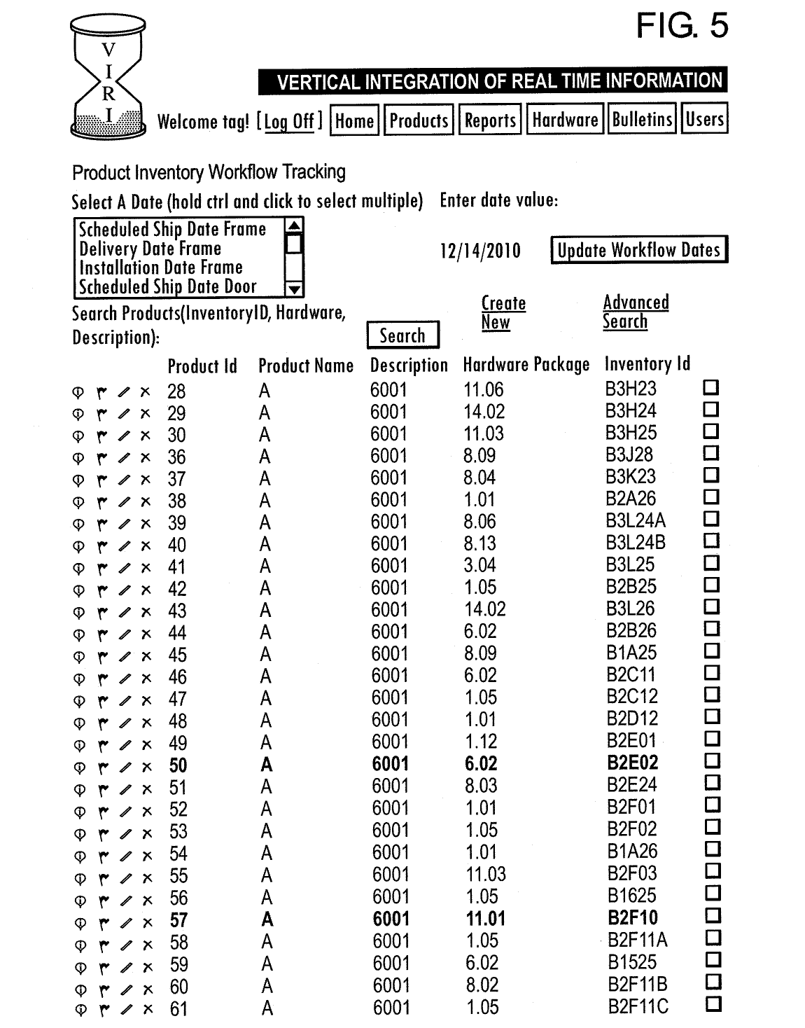

As shown in FIG. 5, the product inventory tracking portal provides a web-based portal for viewing data and connectivity to more detailed related data. For example, pre loaded data pertaining to all of the door openings in a desired building in organized spreadsheet format, with attribute subheadings Product ID, Product Name, Description, Hardware, Package and Inventory. A user can select a specific door number or an icon (pencil in this case) to obtain more related information, which will then open a products portal (FIG. 18) which displays more details relating to the selected attribute.

For example, in a door installation project, door openings and locations can be pre-assigned a unique identifier, or inventory ID in the architectural database, such as B3H23, wherein B3 indicates location, such as, the second floor and H23 indicates the room number on that floor. Detailed information regarding inventory ID B3H23 is saved in a database.

The user selects the identifier, such as, B2F10 for openings. Information pertaining to that identifier is retrieved and displayed in a Products Portal, illustrated in FIG. 18. As shown, related attributes related to the identifier are listed for that particular opening. In the event construction-specific information is entered by a user that does not comply with information stored in the database 18, the software application 12, detects the discrepancy and flags attribute. As previously mentioned, the software application 12 detects discrepancies in data. In this case, a door opening identifier is highlighted on the product inventory tracking portal, whenever a discrepancy in information exists pertaining to that identifier.

The software application 12 in real-time automatically compares information pertaining to the data attributes loaded in the database 18 from data stored in the third party architecture server (preloaded data) to data uploaded locally via the CPU or remotely via the client 20. In comparing preloaded data to present data, discrepancies between said data is detected by the software application 12 and automatically flagged, thereby alerting a user of the discrepancy. In the present embodiment, a discrepancy/comment/RFI is noted and indicated via highlight, or made bold, on the products inventory workflow tracking display screen, FIG. 5.

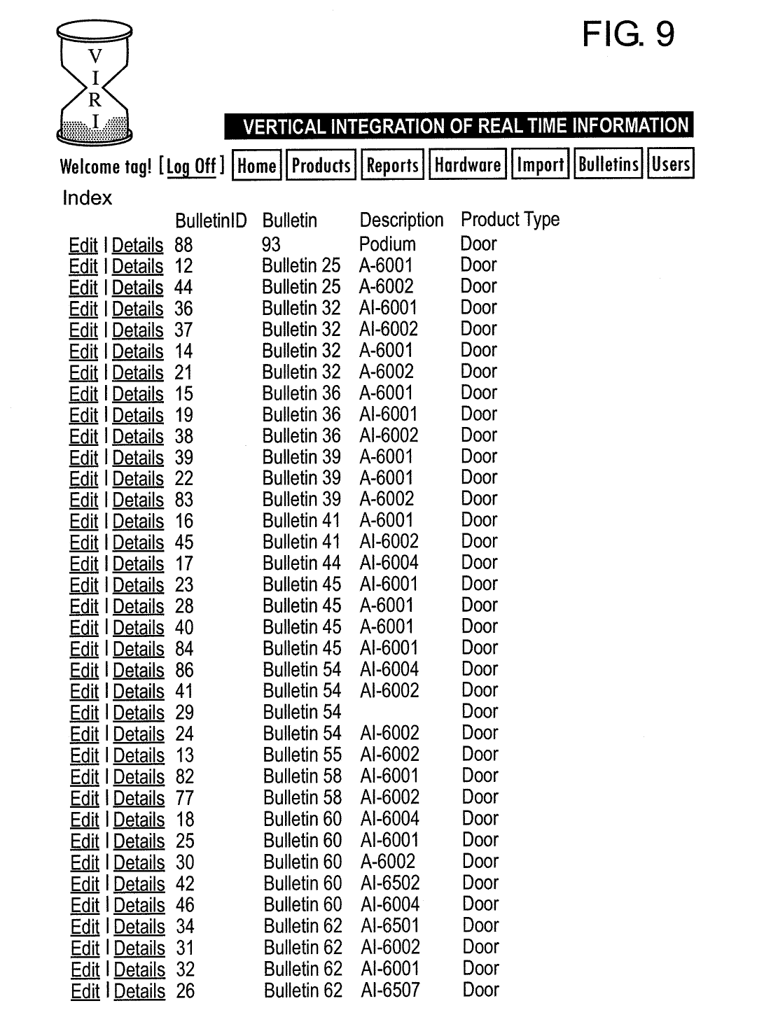

The products user portal provides detailed information of a selected attribute. As shown in FIG. 18, the products portal provides information pertaining to a selected identifier “B2F10”. The products portal provides a field that enables comments or discrepancies to manually be enterer by a user remotely or locally. Further, whenever there is a discrepancy between what the architectural data indicate and what the personnel sees in real time on the ground, that information can be immediately communicated to a home office via the application to resolve the inconsistency between what is at the construction site and the conditions depicted in the architectural drawings. The products portal further indicates related “Bulletins” or change orders, which references information stored and displayable in the Bulletins portal, in FIG. 9.

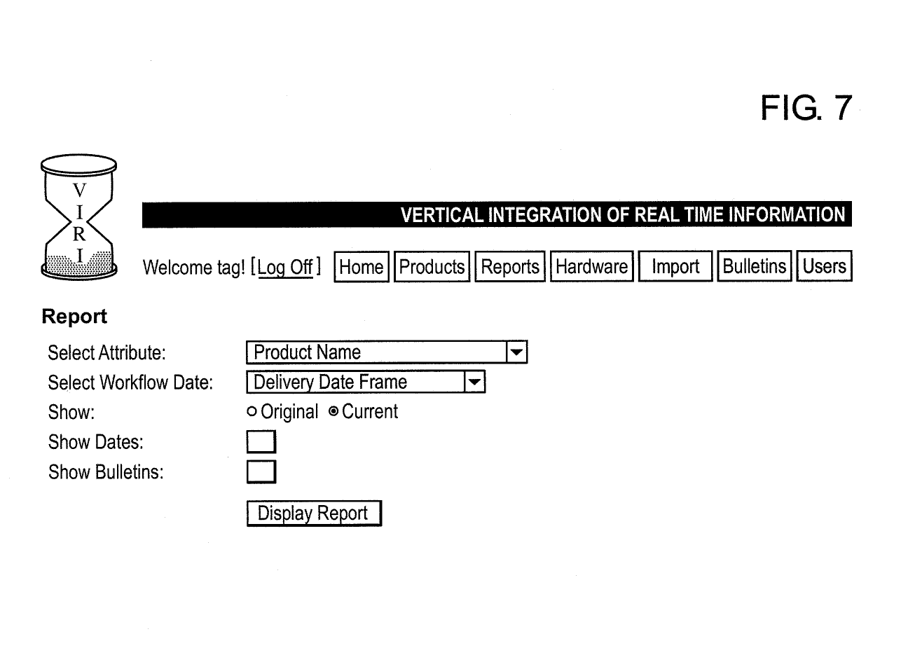

Referring now to FIG. 7, there is shown an example of a reports portal screen display 80 provided by the software application 12. The reports portal 80 enables a user to search the construction-specific data and generate a report based on a desired attribute. For example, a user can activate a search that filters the construction-specific information to provide a list of material delivered or installed on a desired date. In other examples, reports can be produced to identify the doors and frames that have been installed in particular rooms or, by floors, by dates, by installer, changed by a specific change order, or by a specific number overall. It is contemplated that reports can be generated based on any desired pre-loaded attribute. Once a report is generated, information can be filtered to produce reports that can be exported to an Excel spreadsheet and printed.

The software application 12 provides an email feature that enables field personnel to send an email to the home office immediately when a discrepancy between the data is detected. Notably, this feature enables the user to obtain instant explanation for the discrepancy if one is available from the home office. If not, the issue will be highlighted, or made bold, in the system 10 on products inventory page until an answer has been provided and documented in the system 10.

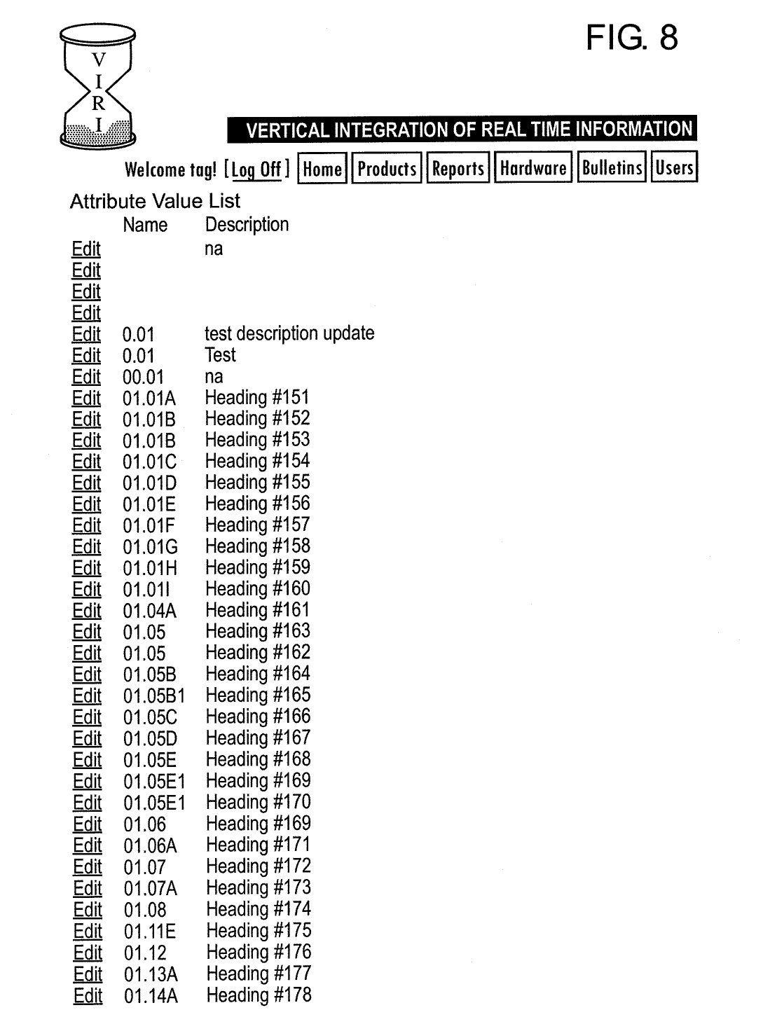

Further, as shown in FIG. 9, a user can see all changes to the architectural drawings (“Bulletins”) that impact some aspect of that particular opening in a “Bulletin index” page. For example, if a user changes the door material or dimensions, that information is entered on the Bulletins or change order page and it automatically updates the changed information on the “attributes value list” page of that particular opening as illustrated in FIG. 8.

On the attributes value list page, a user can select the “Bulletins” tab and then click on a Bulletin affecting the opening, and be linked to the Bulletin's page where they can see what aspects of the attributes for a given opening have been changed. Under the “hardware” tab, all items included in a hardware package are listed in total and the number of each hardware item assigned to each door is listed in a parallel format. For example, the hardware items in the package are listed, the total number of each item is listed, and then the number of each piece of hardware for each opening using that item is listed. New hardware packages can be added on the main “hardware” page. An example of the Hardware page is similar to that illustrated in FIG. 9.

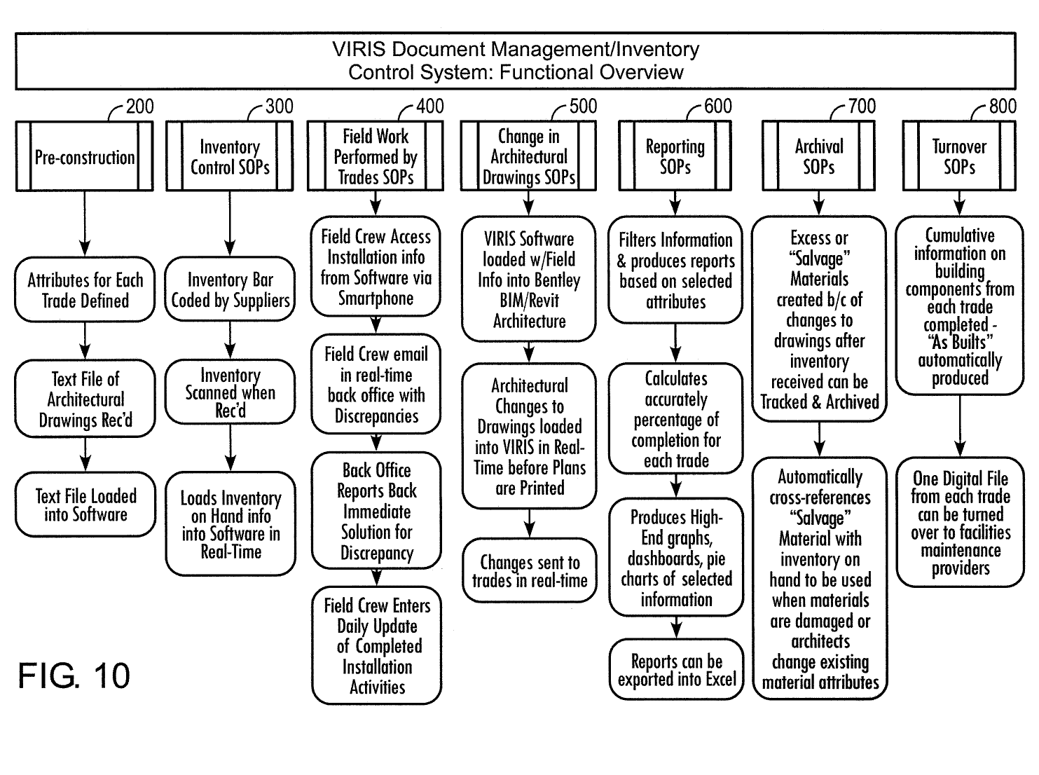

FIG. 10 illustrates a schematic representation of the data information system 10 in accordance with the present invention. As shown, there are several functions performed by the information system 10. The information system 10 performs several functions such as, pre-construction 200, inventory control 300, field work performed by trades Standard Operating Procedures (SOPs) 400, changes to Architectural Drawings SOPs 500, Reporting SOPs 600, Archiving SOPs 700 and Turnover SOPs 800. The information system 10 in cooperation with the software application 12 enables information to be shared between the server 16, database 18, CPU 14 and remote client 20 to access information stored in the data fields in real time.

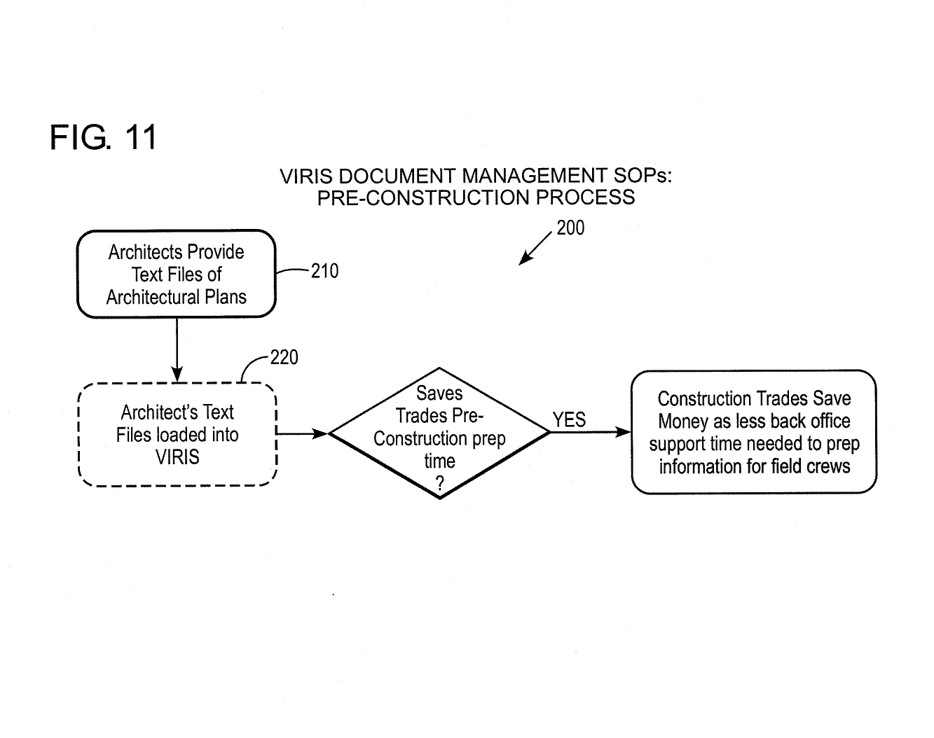

Referring now to FIG. 11 which illustrates a flow diagram of the system 10 using the software application 12 at the pre-construction phase 200. As indicated at step 210 files of the architectural plans are provided, preferably in text format containing data and specifications relating to the materials to be used. The files are loaded into the software application's database 220. Notably, it is contemplated that the information can be loaded into a database compatible and in communication with the software application 12, without departing from the scope of the present invention. Alternatively, the information can be directly transmitted from the BIM software or other design/architectural software. Loading the information into the system reduces the time necessary in the back office to prepare the information for the field personnel 230. Specifically, the software application 12 provides efficiencies in that construction trades save money as less back office support time is needed to prepare information for and by field crews 240, which also results in fewer labor hours spent researching design/architectural data.

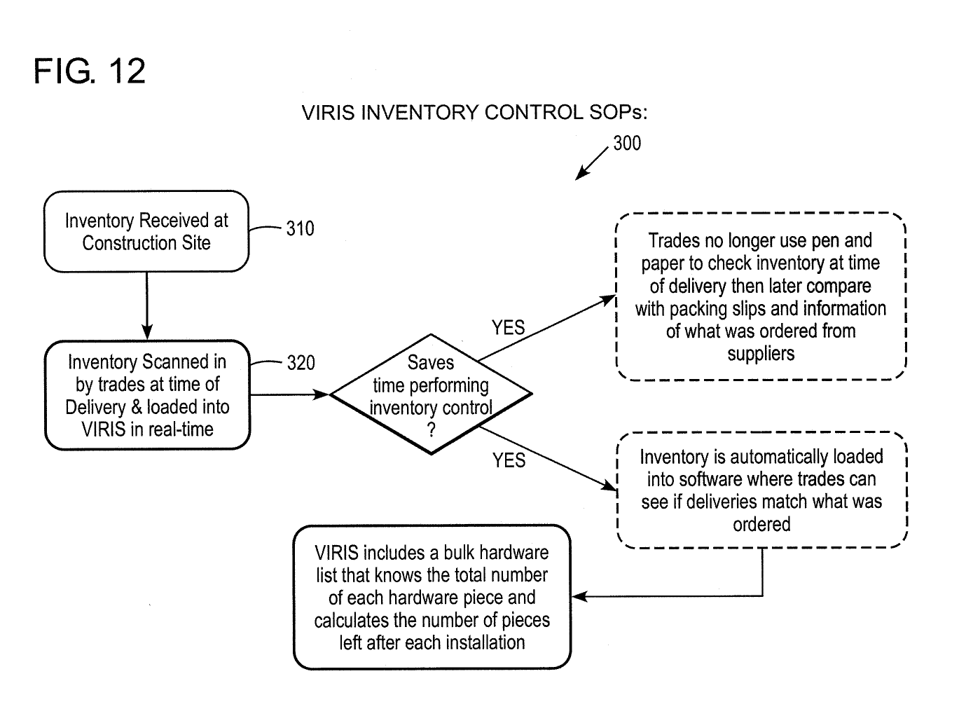

Referring now to FIG. 12, which illustrates the inventory control function 300 operating process and procedures in accordance with the present invention. As illustrated, in step 310 inventory is received at the construction site. In step 320 inventory is scanned by personnel, such as trades, using a mobile client 20 in communication with the software application 12. The client 20 can be an IPad, computer, smartphone (IPhone, Android or Blackberry) or mobile device in conjunction with bar code technology, generally known to those skilled in the art. By scanning the inventory, the inventory data is loaded into the client 20 and transmitted to the server and database. Using the software application 12, personnel can retrieve information from the database in real-time to confirm a delivery. In addition the software application 12 has the complete inventory list pre-loaded, and accordingly maintains real time inventory control and status by comparing incoming inventory data provided at step 320 to inventory data stored on the database 18, which in this example is a bulk hardware list. The software application 12, based on the comparing performed in real time can, for example, display to the user a calculation of the number of hardware pieces that may be left after each installation 330. Thus, the software application 12 provides efficiencies so as to save time performing inventory control 340. Specifically, the software application 12 provides efficiencies in that the trades no longer need to use the time consuming process of using pen and paper to check-off inventory listed on packing slips at the time of delivery as delivered inventory, once scanned in, is automatically loaded into the system. 350. By using the reporting function, inventory information can be filtered by date to confirm the number of inventory items received and match the number of inventory items listed on the packing slip. Simply stated, the software application 12 provides efficiencies that inventory and updates to the inventory are automatically loaded into the software application 12 which permits trades to view deliveries and match what was ordered to what was received 360.

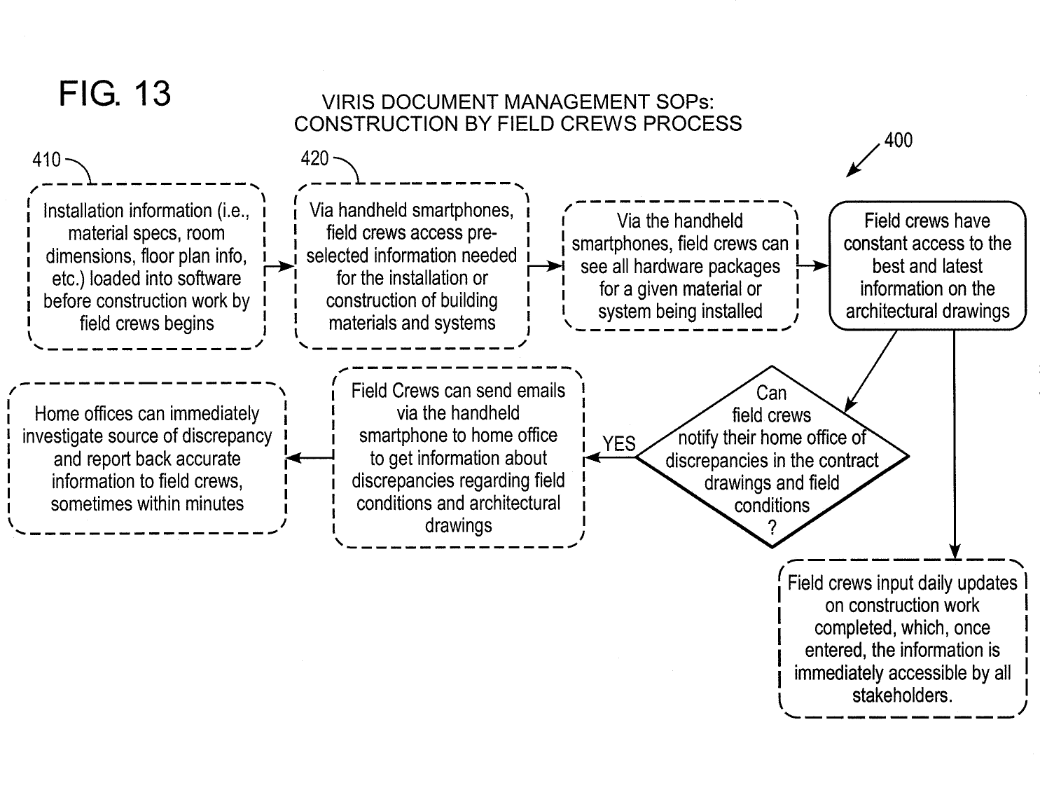

Referring now to FIG. 13, there is shown the document management process 400, in accordance with the present invention. In step 410 installation/construction information (i.e. specifications, room dimensions, floor plans, etc.) is loaded into the application database prior to construction. In step 410, using the software application 12, field personnel can interface with and access and view information stored in the home application database 18, which is viewable using the client 20. Field crews can view all relevant design/architectural information for a preferred project. Accordingly, field personnel can access the information and in real-time, notify the home office maintaining construction information if a discrepancy between the design/architectural drawings and field conditions occurs. If information in the home office database is updated, field personnel can access this information remotely using the software application. In step 420 of the process, field crews input daily updates on construction work completed and this information is transmitted to the server 14 and application 12 and is accessible in real time by office personnel and stakeholders. Thus, according to the present invention home offices can immediately investigate the source of any discrepancy and report back accurate information to field crews, immediately 430. Further, field crews input daily updates on construction work completed, which, once entered, the information is immediately accessible by all stakeholders 440. Thus, the software application 12 provides efficiencies so that field crews can notify their home office of discrepancies in the contract drawings and field conditions 450. Specifically, the software application 12 provides efficiencies in that via handheld smartphones, IPads, computers or other mobile device, field crews can see all hardware packages for a given material or system being installed 460 as such field crews have constant access to the best and latest information on the architectural drawings 470. The software application 12 allows field crews to send emails via the handheld smartphones, IPads, computers or other mobile device to the home office to communicate information about discrepancies regarding field conditions and architectural drawings 480.

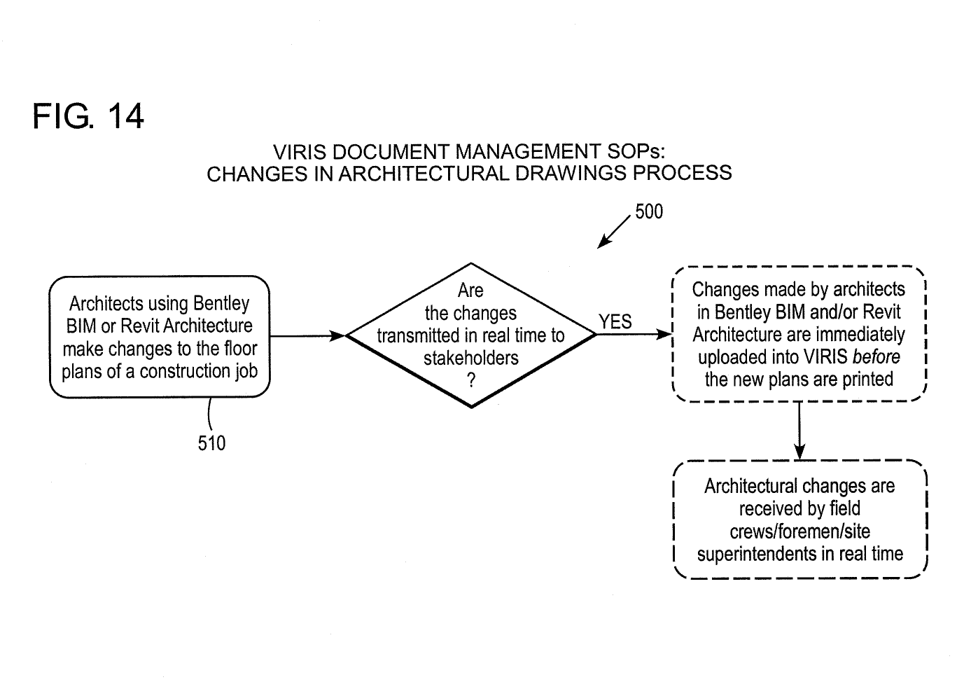

FIG. 14 is a flow diagram 500 illustrating the system 10 process of handling changes to the architectural drawings. As shown in step 510, as personnel such as architects make changes to the construction project, such as floor plan changes, these changes are entered into the database 18 and accessible remotely by field personnel through the client 20, such that these changes can be viewed using the client 20. Thus, the software application 12 provides efficiencies so as to allow for changes to be transmitted in real time to all stakeholders 520. Specifically, the software application 12 provides efficiencies in that changes made by the architects in the BIM software or other design/architectural software are immediately uploaded into the software application 12 before the new plans are printed 530. Further, the changes are received by the field crews in real time 540.

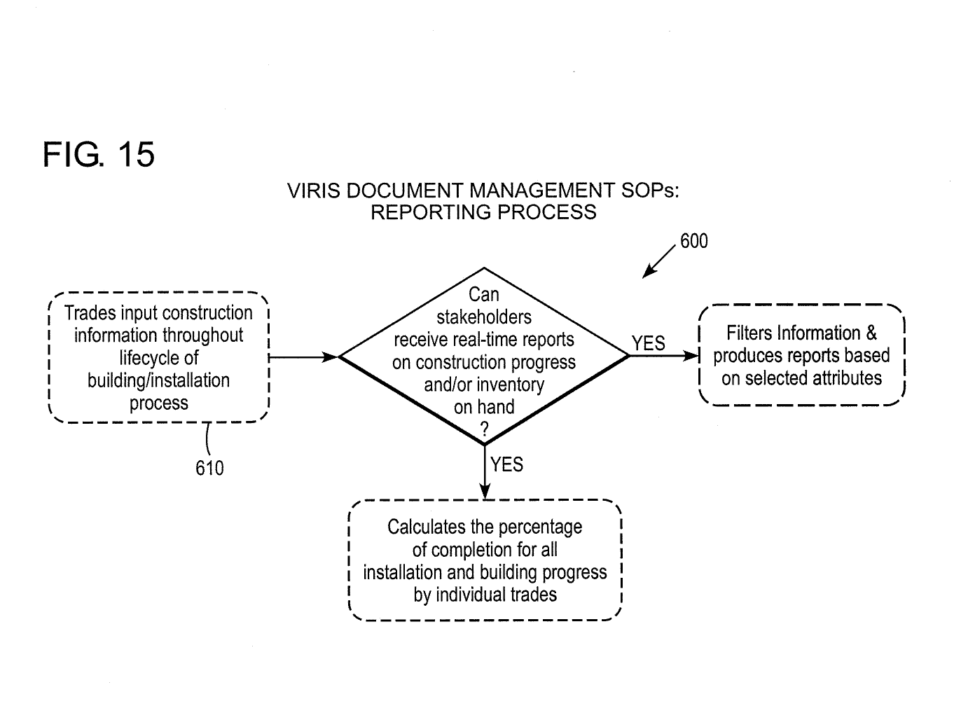

FIG. 15 illustrates the system 10 enabling a construction reporting progress 600. As shown in step 610 as trades input construction information into the client 20, information is transmitted in real-time to the software database 18. Accordingly, the application can generate reports using desired fields. Thus, the software application 12 provides efficiencies so as to allow stakeholders to receive real-time reports on construction progress and/or inventory on hand 620. Specifically, the software application 12 provides efficiencies in that the software application 12 filters information and produces reports based on selected attributes 630. In addition the software application 12, based on the continual inputting and updating of the information, the software application 12 can calculate the percentage of completion for all installation and building progress by individual trades 640. Accordingly, users of the software application 12 can submit pay applications that can be validated based on real-time construction progress information recorded by trades daily in the software application 12. This function of the application replaces the inexact method of validation, which typically involves an owner's representative walking around a project site and eyeballing structures and inventory, “guessing” on whether the percentage completed claimed by the trades is accurate. On a large, complex construction project, “eyeball” validation can result in unnecessary friction between general contractors and trades, as pay applications are often not approved for amounts that minor actual construction progress.

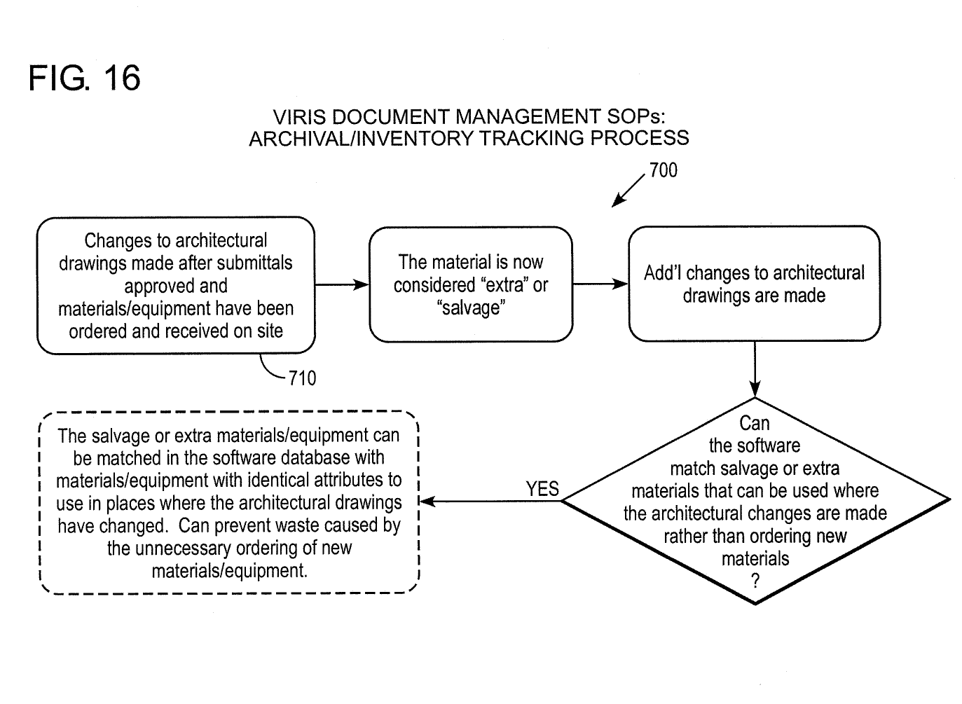

FIG. 16 illustrates a flow diagram of the archiving inventory tracking process 700 of the system 10, in accordance with the present invention. As illustrated in step 710, as any changes to the architectural drawings are made, materials and equipment that are received at the construction site are inventoried and stored in the database 18 such that materials and equipment can be immediately identified as being usable or identified as extra or salvage 720. In the event additional changes are made to the architectural drawings, the software application 12 uses the identifying code stored in the database 18 to identify the materials such that those materials can be used 730. The benefit of this inventorying process is by providing an inventory and query process, the ability to identify items on site will prevent the materials from being reordered. Thus, the software application 12 provides efficiencies so as to match salvage or extra materials that can be used where the architectural changes are made rather than ordering new materials 740. Specifically, the software application 12 provides efficiencies in that the salvage or extra materials or equipment can be matched in the software application 12 with material or equipment with identical attributes to use in places where the architectural drawings have been changed, thereby preventing waste caused by the unnecessary ordering of the materials or equipment 750.

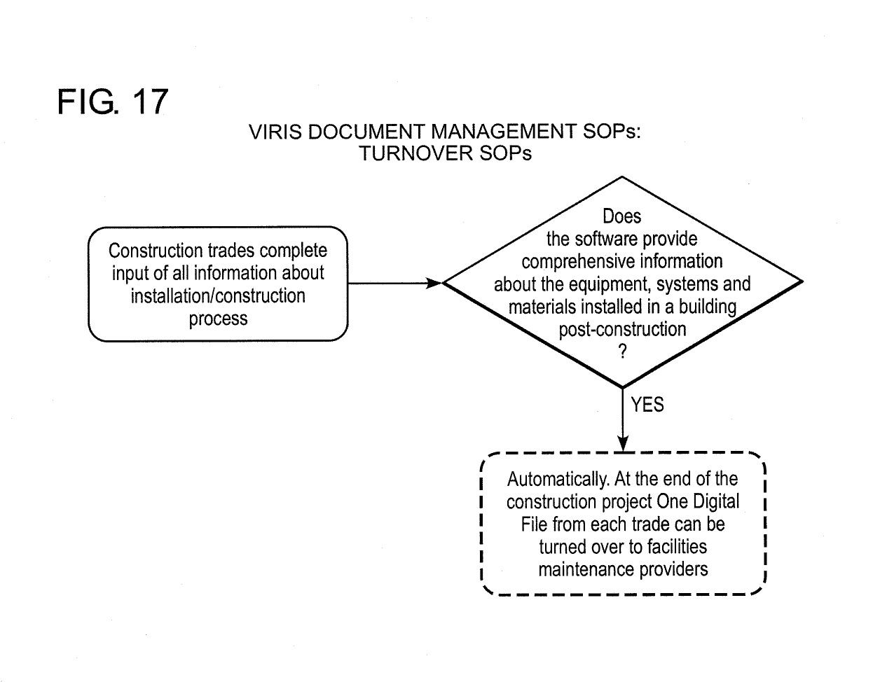

FIG. 17 illustrates a flow diagram of the document management and post construction information at turnover process 800 of the system 10, in accordance with the present invention. As illustrated in step 810, the construction trades complete the input of all information of the installation/construction process, thereby providing a complete set of data from participating trades using the system and documents of the completed project. Thus, the software application 12 provides efficiencies so as to provide comprehensive information from participating trades using the system about the equipment, systems and materials installed in a building post construction 820. Specifically, the software application 12 provides efficiencies in that automatically, at the end of the construction project one digital file for each participating trade can be turned over to facilities maintenance providers 830.

The foregoing examples have been provided merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

### APPENDIX A

Project Data Set
Project ID
Project Name
Project Description
Project_Product Type Data Set
Project ID
Product TypeID
Rules
Attribute Value
Attribute Value ID
Attribute ValueName
Description
Product TypeID
Attribute ID
SubValue
SubValueeID
Sub Value Description
Attribute Value ID
Quantity
Total Quantity
Full Descriptor
Hardware ChangeLog ID
Hardware Package Change Log
Product ID
New Hardware Package ID
Bulletin ID
Comment
Last Updated
Updated By
Attribute
Attribute ID
Attribute Name Product Type ID
Order Number
Product Attribute
Product Attribute ID
Product ID
Attribute ID
Value
Last Updated
Product
Product ID
Product Type ID
Last Updated
Status
Date Created
Product Work Flow ID
Workflow Date ID
Product ID
Comment
Value
Last Updated
Updated By
Product Attribute Change Log
Product Attribute
Change Log ID
Product Attribute ID
Old Value
New Value
Bulletin ID
Product ID
Comment
Discrepancy
Discrepancy ID
Comments
Discrepancy
Status Code
Date Created
Last Updated
Updated By
Product ID
Bulletin
Bulletin ID
Name
Description
Product Type ID
Product Type
Product Type ID
Product Type
Name
Product Type Desc
Work Flow Date
Work Flow Date ID
Work Flow Date Name
Work Flow Date Description
Product Type ID

What is claimed is:

1. An information system process for managing a specified construction project in real-time, comprising a server, database in communication with a computer and a remote client having a software application enabling communication between the server and client wherein the steps comprise:
a. inputting architectural/design drawing data and first construction information set on a server;
b. scanning construction related material data using the client and application and transmitting data to the server;
c. remotely inputting a second construction project installation information set from the specified construction project;
d. comparing the second project installation information set to architectural drawing data and the first project installation information set to ascertain construction information discrepancies and progress.

2. A software application configured to operate with BIM software or other architectural or design software comprising: a database for storing construction specific data a first viewable portal comprising a first series of data fields a second viewable portal comprising a second series of data fields.
